(19) United States
(12) Patent Application Publication
(10) Pub. No.: US 2023/0364536 A1
(43) Pub. Date: Nov. 16, 2023

(54) Swimming Pool Backwash Filtration Device

(71) Applicant: Alexander Tothfalusi, Mount Brydges (CA)

(72) Inventor: Alexander Tothfalusi, Mount Brydges (CA)

(21) Appl. No.: 17/742,555

(22) Filed: May 12, 2022

(51) Int. Cl. B01D 35/157; B01D 29/15; B01D 29/66; B01D 29/56; B01D 35/30; B01D 35/16; C02F 1/00

(52) U.S. Cl. CPC B01D 35/1573; B01D 29/15; B01D 29/66; B01D 29/56; B01D 35/30; B01D 35/16; C02F 1/001; B01D 2201/309; B01D 2201/165; B01D 2201/301; C02F 2103/42

(57) ABSTRACT

A swimming pool backwash filtration device for filtering backwash includes a house. The house has an interior defining a space for a filter to be stored within. The house has an inlet surface and an outlet surface where the inlet surface has an inlet conduit. A y-valve comprises an intake conduit and a pair of exit conduits. The intake conduit is in fluid communication with a pump and a debris filter of a swimming pool. The pair of exit conduits includes a backwash exit conduit and a pool exit conduit. The pool exit conduit is in fluid communication with the inlet conduit of the house.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pool filter device and more particularly pertains to a new pool filter device for filtering backwash.

### (2) Description of Related Art Including Information Disclosed Under 37 CFR 1.97 and 1.98

The prior art relates to pool filter devices. The prior art relates to a variety of pool filter devices configured for filtering water of a swimming pool from debris. Known prior art lacks a pool filter device configured for fine filtering of the backwash from a swimming pool thus recycling the pool water for further use.

### BRIEF SUMMARY OF THE INVENTION

An embodiment of the disclosure meets the needs presented above by generally comprising a house. The house has an interior defining a space for a filter to be stored within. The house has an inlet surface and an outlet surface. The inlet surface has an inlet conduit. A y-valve comprises an intake conduit and a pair of exit conduits. The intake conduit is configured for being in fluid communication with a pump and a debris filter of a swimming pool. The pair of exit conduits comprising a backwash exit conduit and a pool exit conduit. The pool exit conduit is in fluid communication with the inlet conduit of the house.

Furthermore, a method of filtering backwash from a swimming pool includes the step of securing an intake conduit to a y-valve with a swimming pool filter and pump, thus the pump and the filter is in fluid communication with the y-valve. Subsequently, a pool exit of the y-valve couples to an inlet conduit of a house. A filter is positioned within an interior of the house. An outlet conduit of the house attaches to a return port of the swimming pool. The user engages with a lever of a ball valve of the pool exit conduit to begin the flow of water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric kit view of a swimming pool backwash filtration device according to an embodiment of the disclosure.

FIG. 2 is a top view of an embodiment of the disclosure.

FIG. 3 is a side view of an embodiment of the disclosure.

FIG. 4 is a cross-sectional view of an embodiment of the disclosure taken from FIG. 3 of Line 4-4.

FIG. 5 is a detail view of an embodiment of the disclosure.

FIG. 6 is an in-use view of an embodiment of the disclosure.

### DETAILED DESCRIPTION OF THE INVENTION

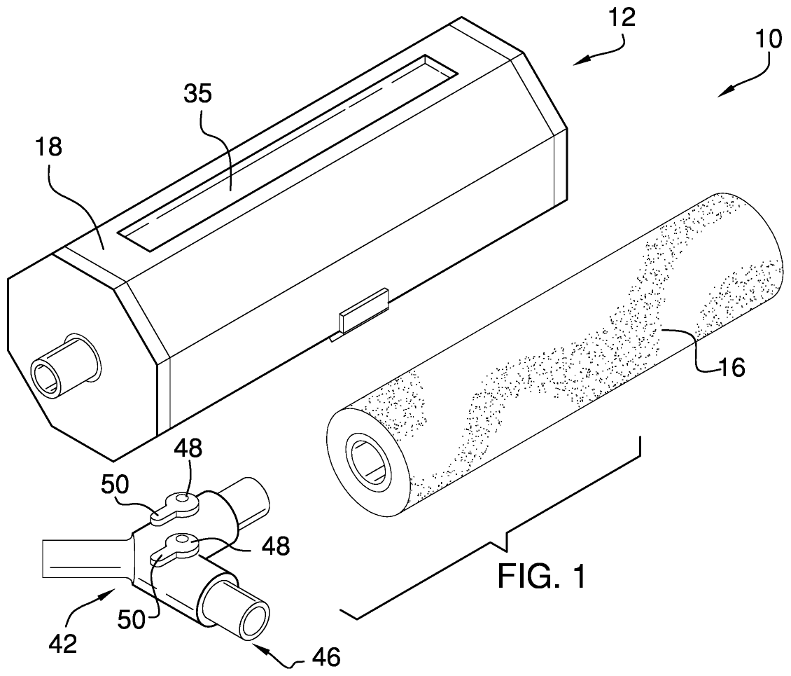

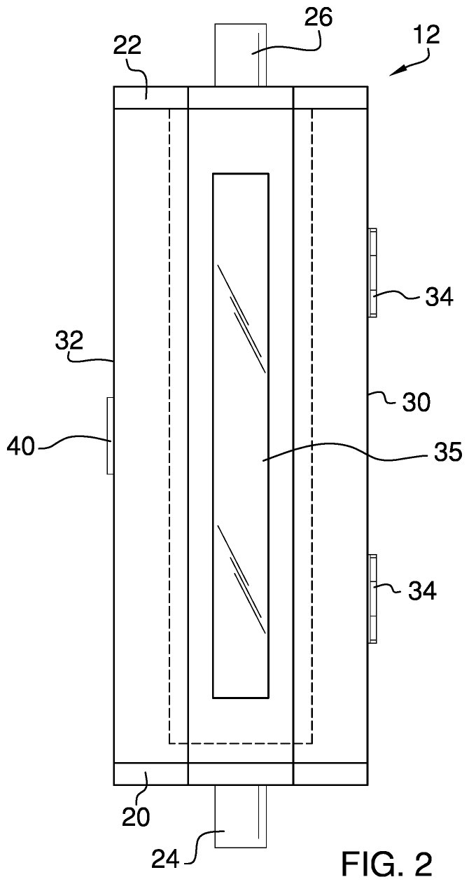

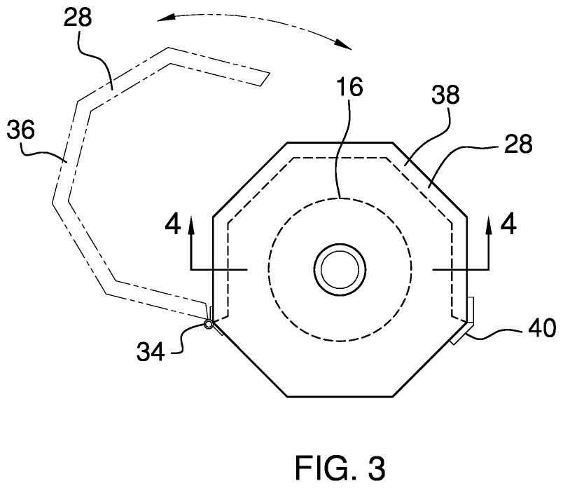

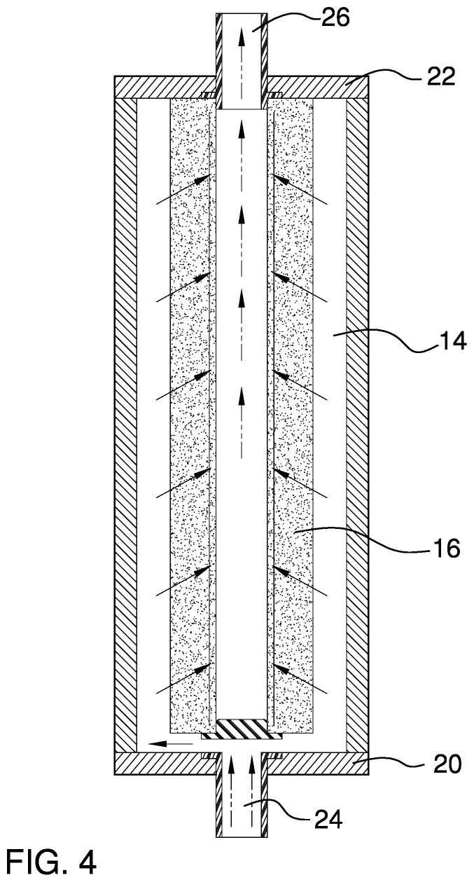

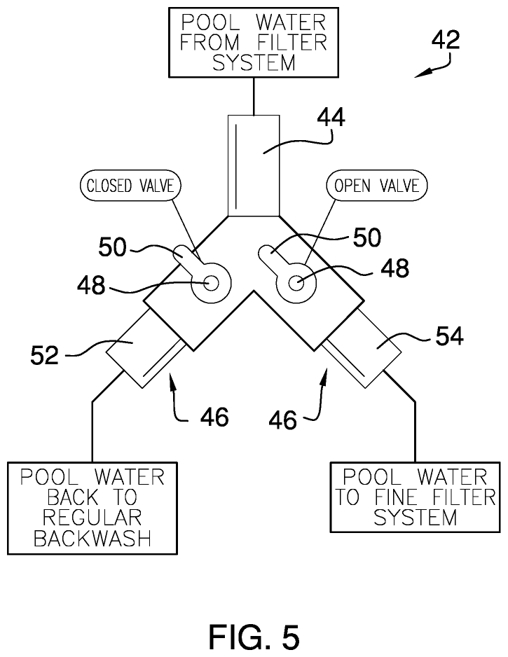

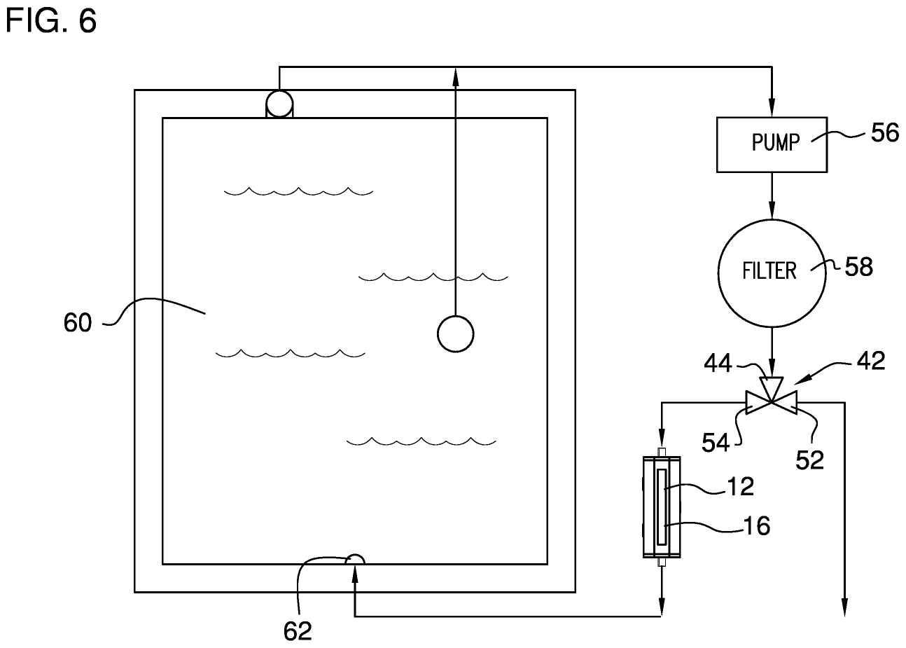

With reference now to the drawings, and in particular to FIGS. 1 through 6 thereof, a new pool filter device embodying the principles and concepts of an embodiment of the disclosure and generally designated by the reference numeral 10 will be described.

As best illustrated in FIGS. 1 through 6, the swimming pool backwash filtration device 10 generally comprises a house 12. The house 12 has an interior 14 that defines a space for a filter 16 to be stored within. The house 12 has a plurality of walls 18 in an octagonal shape. Additionally, the house 12 has an inlet surface 20 and an outlet surface 22. The inlet 20 and outlet 22 surfaces are positioned perpendicular relative to the plurality of walls 18 of the house 12, thus the inlet 20 and outlet 22 surfaces are parallel relative to each other. The inlet surface 20 of the house 12 has an inlet conduit 24, and the outlet surface 22 of the house 12 has an outlet conduit 26.

Furthermore, the inlet conduit 20 of the house 12 is configured for flowing water into the interior 14 of the house 12. Within the interior 14 of the house 12, the filter 16 is configured for filtering the water flowing in. The outlet conduit 26 of the house 12 is configured for expelling the filtered water from within the house 12. The filter 16 is configured for being a fine filter thus filtering the particles within the water.

The interior 14 of the house 12 can be accessed by a door 28. The door 28 is positioned on a side of the house 12. The door 28 has a first edge 30 where a pair of hinges 34 is positioned. The pair of hinges 34 is configured for positioning the door 28 from an open position 36 to a closed position 38, and vise versa. The door 28 has a lock positioned on a second side 32 of the door 28. The lock 40 is configured for retaining the door 28 in a closed position 38 until the user engages with a locking mechanism of the lock 40 to release the door 28 into an open position 36. Furthermore, a window 35 is positioned on the door 28. The window 35 is transparent and is configured for viewing the interior 14 of the house 12 when the door 28 is in a closed position 36.

Additionally, the swimming pool backwash filtration device 10 comprises a y-valve 42. The y-valve 42 includes an intake conduit 44 and a pair of exit conduits 46. The pair of exit conduits 46 is positioned on an end of the intake conduit 44 and protrudes outward therefrom. Each of the exit conduits 46 has a ball valve 48 connected to a lever 50. The lever 50 of the ball valve 48 of each of the exit conduits 46 is configured for opening and closing the flow of water for each exit conduit 46.

The pair of exit conduits 46 comprises a backwash exit conduit 52 and a pool exit conduit 54. The backwash exit conduit 52 is configured for draining the backwash from the pool system. The pool exit conduit 54 is configured for flowing the backwash to the house 12 for filtration before reentering the swimming pool 60. The water is provided from the intake conduit 44 which is in fluid communication with a pump 56 and a debris filter 58 of a swimming pool 60.

In use, the intake conduit 44 of the y-valve 42 is secured to the debris filter 58 of the swimming pool 60. The debris filter 58 is in fluid communication with a pump 56 which induces the force of flow to the water along the filtration system. Subsequent to securing the intake conduit 44 to the debris filter 58, the pool exit conduit 54 of the y-valve 42 couples to the inlet conduit 44 of the house 12. The backwash exit conduit 52 can be coupled to a hose or another conduit for removal of the backwash from the swimming pool 60. The outlet conduit 26 of the house 12 attaches to a return port 62 of the swimming pool 60. The levers 50 of the pair of exit conduits 46 are engaged with to enable the water to flow through the pool exit conduit 54 and be blocked from the backwash exit conduit 52. In addition, the levers 50 of the pair of exit conduits 46 can be engaged with to block the pool exit conduit 54 and open the backwash exit conduit 52 when backwash is needed to be removed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A swimming pool backwash filtration assembly configured for filtering backwash from a swimming pool for reuse, the assembly comprises:
a house having an interior, the interior defines a space for a filter to be stored within, the house having an inlet surface and an outlet surface, the inlet surface having an inlet conduit; and
a y-valve comprising an intake conduit and a pair of exit conduits, the intake conduit being configured for being in fluid communication with a pump and a debris filter of a swimming pool, the pair of exit conduits comprising a backwash exit conduit and a pool exit conduit, the pool exit conduit being in fluid communication with the inlet conduit of the house.

2. The swimming pool backwash filtration assembly of claim 1, further comprising the house having a plurality of walls, the plurality of walls being an octagonal shape.

3. The swimming pool backwash filtration assembly of claim 1, further comprising the outlet surface having an outlet conduit.

4. The swimming pool backwash filtration assembly of claim 1, further comprising the inlet conduit being configured for flowing water into the interior of the house, the filter being configured for filtering the water within the interior of the house, the outlet conduit being configured for expelling the filtered water from the interior of the house.

5. The swimming pool backwash filtration assembly of claim 1, further comprising the house having a door, the door being configured for providing access to the interior of the house.

6. The swimming pool backwash filtration assembly of claim 1, further comprising the door having a pair of hinges, the pair of hinges of the door being configured for positioning the door in an open and closed position.

7. The swimming pool backwash filtration assembly of claim 1, further comprising the door having a lock, the locking being configured for retaining the door to the house wherein enclosing the interior of the house.

8. The swimming pool backwash filtration assembly of claim 1, further comprising a window being positioned on said door, said window being transparent.

9. The swimming pool backwash filtration assembly of claim 1, further comprising each of the exit conduits having a ball valve, the ball valve of each of the exit conduits having a lever, the lever of the ball valve of each of the exit conduits being configured for opening and closing the flow of water.

10. The swimming pool backwash filtration assembly of claim 1, further comprising the backwash exit conduit being configured for draining out of the pool, the pool exit conduit being configured for draining into the interior of the house.

11. A swimming pool backwash filtration assembly configured for filtering backwash from a swimming pool for reuse, the assembly comprises:
a house having an interior, the interior defines a space for a filter to be stored within, the house having a plurality of walls, the plurality of walls being an octagonal shape, the house having an inlet surface and an outlet surface, the inlet surface having an inlet conduit, the outlet surface having an outlet conduit, the inlet conduit being configured for flowing water into the interior of the house, the filter being configured for filtering the water within the interior of the house, the outlet conduit being configured for expelling the filtered water from the interior of the house, the house having a door, the door being configured for providing access to the interior of the house, the door having a pair of hinges, the pair of hinges of the door being configured for positioning the door in an open and closed position, the door having a lock, the locking being configured for retaining the door to the house wherein enclosing the interior of the house, a window being positioned on said door, said window being transparent; and
a y-valve comprising an intake conduit and a pair of exit conduits, the intake conduit being configured for being in fluid communication with a pump and a debris filter of a swimming pool, each of the exit conduits having a ball valve, the ball valve of each of the exit conduits having a lever, the lever of the ball valve of each of the exit conduits being configured for opening and closing the flow of water, the pair of exit conduits comprising a backwash exit conduit and a pool exit conduit, the backwash exit conduit being configured for draining out of the pool, the pool exit conduit being configured for draining into the interior of the house, the pool exit conduit being in fluid communication with the inlet conduit of the house.

12. A method of filtering backwash from a swimming pool, the method including the step of:
securing an intake conduit to a y-valve with a swimming pool debris filter and pump thus the pump and the debris filter being in fluid communication with the y-valve;
coupling a pool exit conduit of the y-valve to an inlet conduit of a house; a filter being positioned within an interior of the house;
attaching an outlet conduit of the house to an return port of the swimming pool; and
engaging with a lever of a ball valve of the pool exit conduit to begin the flow of water.
